(19) United States
(12) Patent Application Publication
(10) Pub. No.: US 2009/0113794 A1
(43) Pub. Date: May 7, 2009

(54) Corner planter

(76) Inventors: Claude R. Smith, Fort Lauderdale, FL (US); Sherrie D. Smith, Fort Lauderdale, FL (US)

Correspondence Address: LITMAN LAW OFFICES, LTD., POST OFFICE BOX 15035, CRYSTAL CITY STATION, ARLINGTON, VA, 22215-0035, US

(21) Appl. No.: 12/289,523

(22) Filed: Oct. 29, 2008

Related U.S. Application Data
(60) Provisional application No. 60/996,141, filed on Nov. 2, 2007.

(51) Int. Cl. A01G 9/02

(52) U.S. Cl. 47/65.5

(57) ABSTRACT

The corner planter is a receptacle having rear walls configured to neatly fit in a corner. Pockets are provided on the rear walls of the planter for housing structure to affix the planter to the walls of the corner. The pockets are designed to allow the planter to fit flush with the walls of the corner. Notches are formed in the top edges of the rear walls of the planters to aid in the location of affixing structure

### CROSS-REFERENCE TO RELATED APPLICATION

This application claims the benefit of U.S. Provisional Patent Application Ser. No. 60/996,141, filed Nov. 2, 2007.

### BACKGROUND OF THE INVENTION

1. Field of the Invention

The present invention generally relates to decorative receptacles. More specifically, the present invention is drawn to a corner planter configured to fit and be affixed in a corner of a room, patio wall, or the like, or on a column.

2. Description of the Related Art

Positioning planters filled with attractive foliage at strategic places of the yard, porch or room is almost guaranteed to add a bit of cheer to the particular environment. Often, unfortunately, the prime location for the planter involves a corner or round column. Positioning a conventional planter at such locations presents an awkward and unbalanced look. It would certainly be advantageous if the planter were configured to fit neatly in the corner or on the column, particularly if planter could also be conveniently and securely affixed thereto. Thus, a corner planter configured to solve the aforementioned problems is desired.

### SUMMARY OF THE INVENTION

The corner planter comprises a receptacle having rear walls configured to neatly fit the walls of an inside corner or an outside corner. Alternatively, the rear wall may be configured to neatly fit a round column. Pockets are provided on the rear walls of the planters for housing fasteners to affix the planters to the walls of the corners or to the column. The pockets are designed to allow the planter to fit flush with the walls of the corner or column. Notches are formed in the rear walls of the planters to aid in the location of affixing fasteners.

Accordingly, the invention presents planter structure that can be easily attached to corner or column walls. The invention incorporates hanger structure that permits the planter to fit flush with the corner or column walls. The invention provides for improved elements thereof in an arrangement for the purposes described that are inexpensive, dependable and fully effective in accomplishing their intended purposes.

These and other features of the present invention will become readily apparent upon further review of the following specification and drawings.

### BRIEF DESCRIPTION OF THE DRAWINGS

FIG. 1 is an environmental, perspective view of a corner planter suspended from an outside corner wall according to the present invention.

FIG. 2 is an environmental, perspective view of a corner planter suspended from an inside corner wall according to the present invention.

FIG. 3 is an environmental top view, partially in section, showing the hanger pocket structure of an outside corner planter according to the present invention.

FIG. 4 is a side view of an outside corner planter according to the present invention, broken away and partially in section to show the hanger pocket structure.

FIG. 5 is an environmental top view, partially in section, showing the hanger pocket structure of an inside corner planter according to the present invention.

FIG. 6 is an environmental top view, partially in section, showing the hanger pocket structure of a column-supported planter according to the present invention.

Similar reference characters denote corresponding features consistently throughout the attached drawings.

### DETAILED DESCRIPTION OF THE PREFERRED EMBODIMENTS

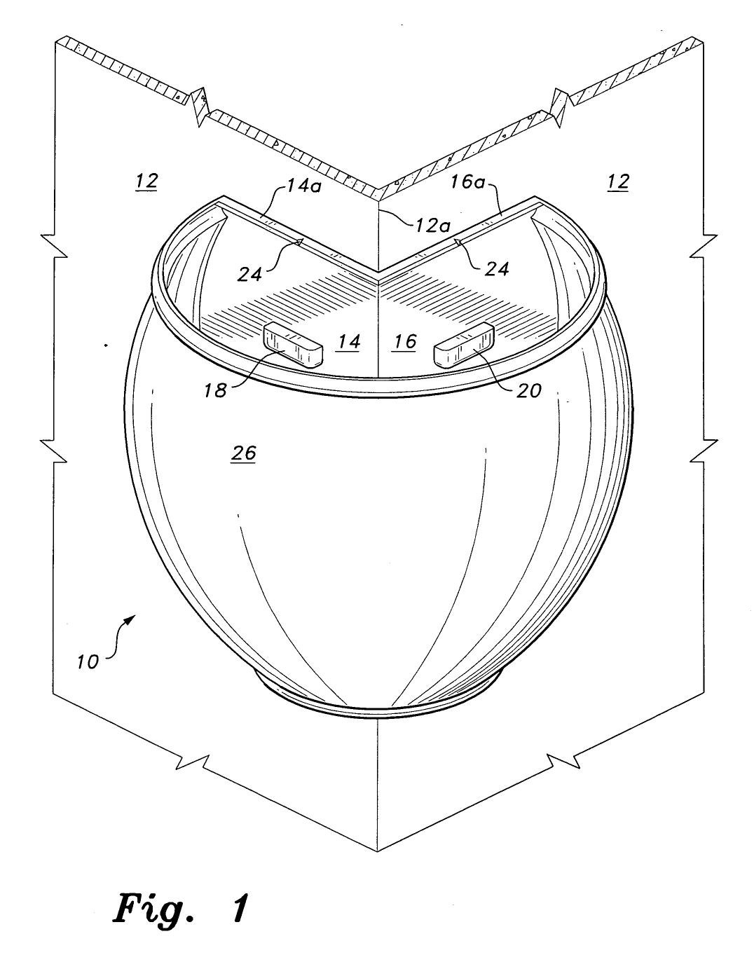

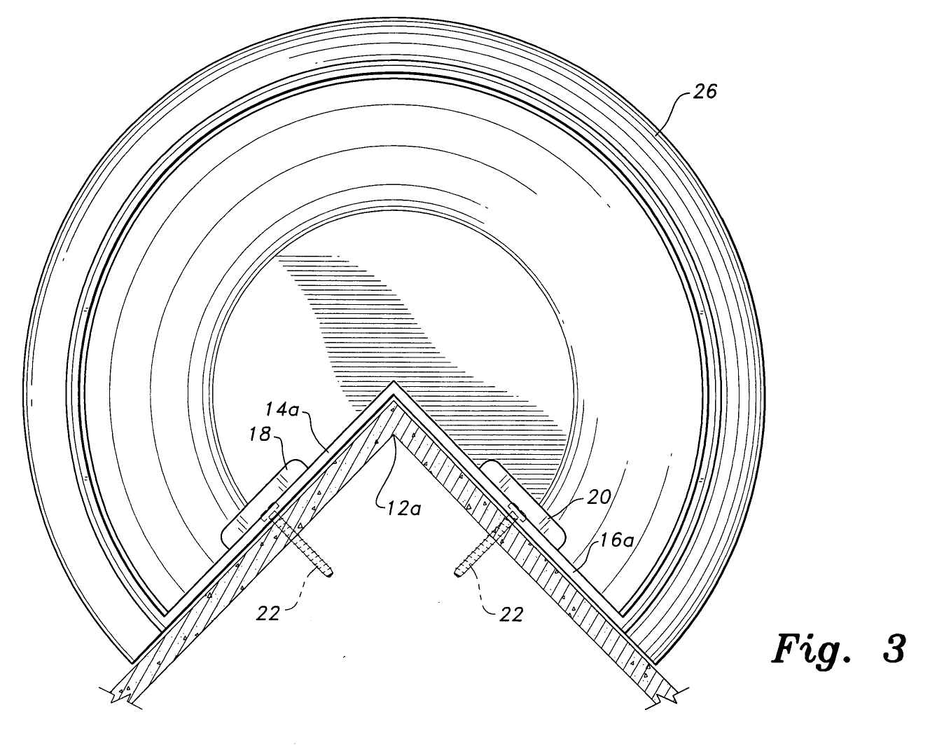

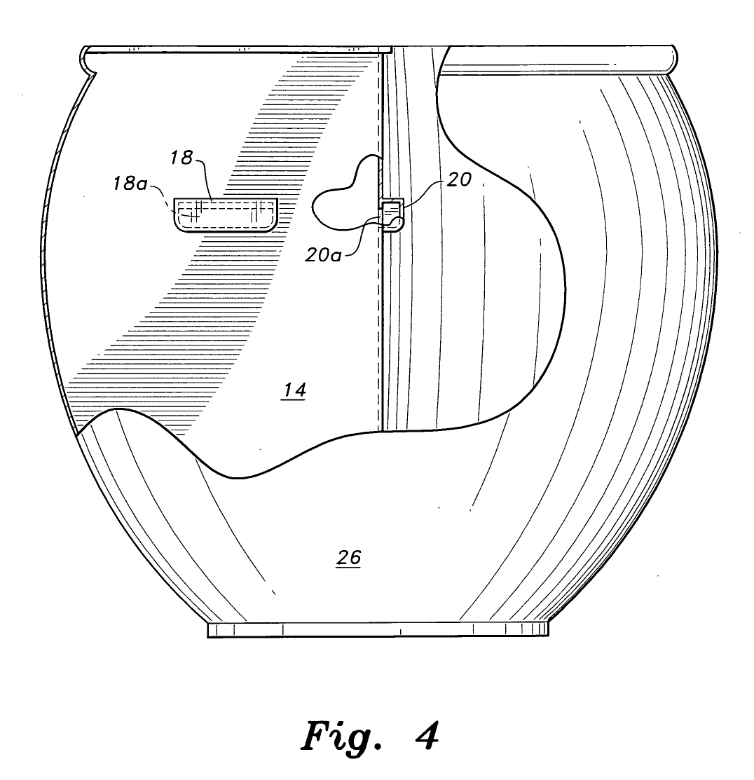

Attention is first directed to FIGS. 1, 3 and 4 wherein a first embodiment of the corner planter is generally indicated at 10. Planter 10 is supported on a wall or structure 12 having an outside corner 12a. Planter 10 comprises rear walls 14, 16 configured to intersect such that the outer surfaces of walls 14, 16 form an angle of 90°, wherein the inner surfaces of the planter 10 form an angle of 270 degrees. This configuration permits planter 10 to fit neatly on outside corner 12a of wall or structure 12. Respective lips 14a, 16a are disposed at the upper edges of walls 14, 16. Respective pockets 18, 20 are disposed on the inner surface of each wall 14, 16. Pockets 18, 20 are sealed, except for respective openings 18a and 20a. Openings 18a and 20a are provided for the insertion of screws 22 or other fasteners for affixing the planter 10 on the wall or structure 12. V-shaped notches 24 are provided on the walls 14, 16 of the planter 10 in alignment with the respective openings 18a and 20a in the pockets 18, 20 to aid in positioning the planter 10 on wall 12. The front wall of the planter 10 is illustrated as a round outer face 26. It is noted, however, that outer face 26 can be fabricated in other configurations and designs, as desired.

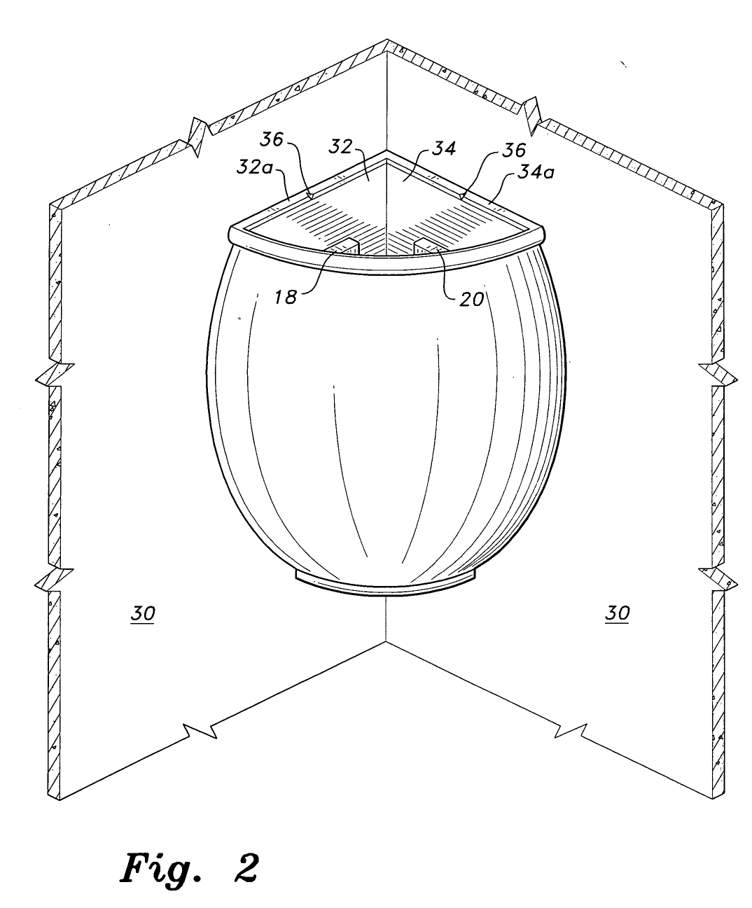

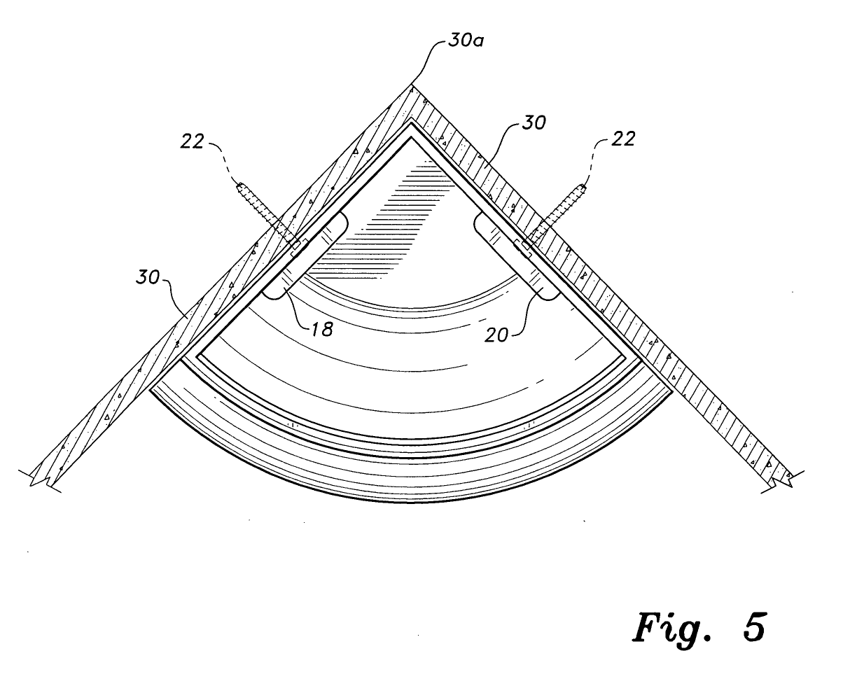

As best seen in FIGS. 2 and 5, a second embodiment of the corner planter is configured to be affixed to a wall or structure 30 having an inside corner 30a. In this embodiment, the inner surfaces of planter rear walls 32, 34 form an angle of 90°, whereas the outer surfaces form an angle of 270°. Pockets 18 and 20 are employed to house fasteners (as described above) to affix the planter to the inside corner walls. Planter walls 32, 34 are provided with lips 32a, 34a and V-shaped notches 36 for reasons discussed above.

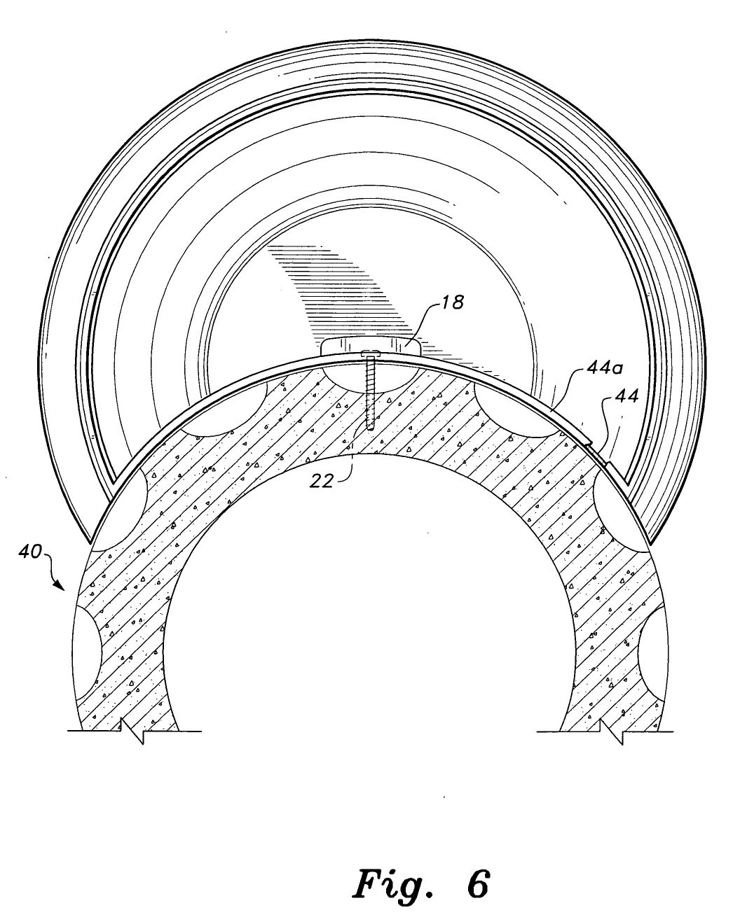

The planter of FIG. 6 illustrates a third embodiment configured to be affixed to a column 40 having a round outer surface. The rear wall 44 of the planter is concave (outer surface) to fit snugly with the curved surface of column 40. The inner convex surface of rear wall 44 is provided with a pocket 18 for housing a fastener 22. A lip 44a is provided at the top edge of rear wall 44. The rear wall can be fabricated with rear walls of different diameters to fit different sized columns.

It is to be understood that the present invention is not limited to the embodiments described above, but encompasses any and all embodiments within the scope of the following claims.

We claim:

1. A planter, comprising:
a receptacle having at least one rear wall, the rear wall having an inner surface and an outer surface; and
a pocket structure disposed on the inner surface of the rear wall, the rear wall having an aperture formed therethrough opening into the pocket structure.

2. The planter according to claim 1, wherein said at least one rear wall comprises two rear walls, each of the rear walls having the pocket structure and the aperture therethrough opening into the respective pocket structure.

3. The planter according to claim 2, wherein the outer surfaces of said two rear walls intersect to form a ninety-degree angle with each other.

4. The planter according to claim 2, wherein the inner surfaces of said two rear walls intersect to form a ninety-degree angle with each other.

5. The planter according to claim 1, wherein the outer surface of said at least one rear wall is concave.

6. A planter, comprising:
a receptacle having a front wall and two rear walls enclosing a volume, each of the rear walls having an inner surface and an outer surface;
two pocket structures, each of the rear walls having a respective one of the pocket structures disposed on the inner surface thereof, each of the pocket structures enclosing a space, each of the rear walls having an aperture formed therethrough opening into the enclosed space of the corresponding pocket structure.

7. The planter according to claim 6, wherein each said rear wall has an upper edge and a respective lip the upper edge.

8. The planter according to claim 6, wherein each said rear wall has an upper edge, a lip defining the upper edge, and a positioning notch disposed in the upper edge.

9. The planter according to claim 8, wherein the outer surfaces of said two rear walls intersect to form a ninety-degree angle with each other.

10. The planter according to claim 8, wherein the inner surfaces of said two rear walls intersect to form a ninety-degree angle with each other.

11. A planter, comprising:
a receptacle having a front wall and a rear wall enclosing a volume, the rear wall having an inner convex surface and an outer concave surface; and
a pocket structure enclosing a space, the pocket structure being disposed on the inner convex surface of the rear wall, the rear wall having an aperture formed therethrough opening into the enclosed space of the pocket structure.

12. The planter according to claim 11, wherein said rear wall has a top edge and a lip defining the top edge.
